(19) United States
(12) Patent Application Publication
(10) Pub. No.: US 2019/0300723 A1
(43) Pub. Date: Oct. 3, 2019

(54) GRAPHENE CONTAINING COATINGS, PRODUCTION PROCESS THEREOF AND USE

(71) Applicant: South Dakota Board of Regents, Pierre, SD (US)

(72) Inventors: Venkata K.K. Upadhyayula, Umeå (SE); Venkataramana Gadhamshetty, Rapid City, SD (US); Govindarajan Chilkoor, Rapid City, SD (US); Mats Tysklind, Umeå (SE)

(73) Assignee: South Dakota Board of Regents, Pierre, SD (US)

(21) Appl. No.: 16/440,674

(22) Filed: Jun. 13, 2019

Related U.S. Application Data
(63) Continuation of application No. PCT/US16/66448, filed on Dec. 14, 2016.

(51) Int. Cl. C09D 5/08; C09D 167/08; C09D 163/00; C09D 133/02; C09D 163/04; C09D 7/20

(52) U.S. Cl. CPC C09D 5/084; C09D 167/08; C09D 7/20; C09D 133/02; C09D 163/04; C09D 163/00

(57) ABSTRACT

The present invention relates to a coating composition for application on metal substrates intended for contact with biofuel, which composition includes graphene and/or graphene oxide, and a polymer. The present invention further relates to the manufacture of the composition, a method of providing the application onto substrates and the use of the composition within biofuel areas.

### CROSS-REFERENCE TO RELATED APPLICATIONS

This application is a continuation of International Application No PCT/US16/66448, filed Dec. 14, 2016, which is incorporated by reference in its entirety.

### FIELD OF THE INVENTION

The present invention relates to graphene based anticorrosive coating compositions for biofuel containing containers, their method of production and use within the field of biofuel storage.

### BACKGROUND

Biodiesel is a typical fuel used in transportation sector. It meets renewable fuel standards developed by environmental regulatory agencies across the world.

Similar to other biofuels, biodiesel poses corrosion risks to metal components of storage infrastructure. For example, biodiesel can result in abiotic and biotic forms of corrosion in metal tanks. A combination of prevention strategies is required to prevention corrosion in the storage tanks.

One industrial standard to minimize corrosion is to incorporate commercial liners throughout interior surfaces of biodiesel tanks. It is also common to supplement biodiesel with biocides to prevent microbial growth and subsequent microbial corrosion. However, biocides can cause environmental and human health impacts. A body of literature suggests that long-term human exposure to biocides results in potential disruption of endocrine activity, and causes other complications such development of malignant lung tumors.

Biodiesel is defined as a mixture of mono-alkyl esters of long chain fatty acids. It can be derived from vegetable oils or animal fats. It is characterized by biodegradable and non-toxic fuel properties. It can be derived from both renewable feedstocks such as jatropha oil, and yet possesses high cetane number and is compatible with majority of the diesel engines. A typical biodiesel has lower levels of sulfur and aromatic compounds, compared to petroleum diesel. It is an environmentally friendly fuel as its combustion results in reduced levels of soot, greenhouse gases, particulate matter, and sulfur dioxide.

However, its physico-chemical characteristics are known to promote metallic corrosion in storage and transportation infrastructure. Further, its hygroscopic properties can allow development of a water phase in a flow-through (low-velocity pipelines) and stagnant conditions (fuel storage tanks) resulting in metal-water-biodiesel interfaces on interior surfaces of biodiesel tanks. These interfaces provide more palatable form of carbon source that favor growth of microbes (e.g., sulfate-reducing bacteria and fungi) typically involved in fermentation (i.e., acid production) and microbial corrosion. A series of technologically relevant metals including mild steel and low carbon steel used in biodiesel storage are prone to microbial corrosion. The corrosion risks due to biodiesel are high compared to typical diesels.

Biofuel industries invest significant financial resources to detect, monitor, prevent, and eradicate biofilm growth. Post-maintenance techniques such as flushing and thermal treatment are expensive and in fact, they aggravate corrosion problems by dislodging passivation layers on metal surfaces. Chemical treatment (e.g., use of oxidizing and non-oxidizing biocides) is an effective method for controlling microbial induced corrosion issues but they pose environmental risks.

Industrial standards used to minimize corrosion of biofuel storage tanks and associated infrastructure involves two forms of protection. First, an epoxy liner is incorporated on interior surfaces of a storage tank. Second, a biocide is added to the biofuel. Epoxy liners are a logical choice for steel industries for the following reasons. They minimize abiotic corrosion and offer excellent mechanical strength. Further, epoxy liners adhere to a variety of metal substrates. A disadvantage with epoxy liners is that they represent a class of reactive prepolymers that are prone to biodegradation, which can be accelerated in presence of carbon-rich biodiesel. Therefore, it is inevitable to use biocides (e.g., triazine) to prevent microbial growth in biodiesel tanks. However, a long-term exposure of biocides can pose health risks to humans and aquatic life. It is therefore important to develop a sustainable alternative to biocides in biodiesel storage tanks. There is also a need to develop greener solutions for preventing metallic corrosion in biodiesel tanks.

### SUMMARY OF THE INVENTION

The present invention provides solutions to the above mentioned problems. By providing biodiesel storage tanks with a lining of the composition according to the present invention the interior surfaces of biofuel, such as biodiesel, tanks are protected against microbial corrosion.

The present invention either reduces or completely eliminates the use of biocides in the biofuel and as such provides less negative imprint on the environment and health of humans and animals.

Composites including graphene and/or graphene oxides have been found to protect metals against microbial induced corrosion in the biofuel industry.

In view of the above, coatings, also referred to as liners, comprising the present composition are environmentally beneficial.

It is to be noted that biocides present in the biofuel according to conventional techniques can eventually reach combustion engines in biodiesel-based cars and influence their air pollution profiles. However, coatings according to the present invention are retained in the storage tanks and do not reach combustion engines and thus pose minimal air pollution risks.

One objective of the present invention is to provide a coating composition for application on metal substrates intended for contact with biofuel, which composition comprises graphene and/or graphene oxide, and a polymer. Optionally, additional materials such as curing agent and/or an organic solvent may be included in the coating composition. The mixture of graphene material, polymer and a curing agent is considered a nonvolatile portion (solid content) of the coating composition, whereas the organic solvent which escapes from the metal substrate after the coating is applied is the volatile portion of the coating composition. In one embodiment the amount of graphene or graphene oxide present in the composition is about 0.1-8 wt. %, preferably 0.1-5 wt. %, preferably 0.2-2 wt. %, preferably 0.2-1 wt. %.

In one embodiment the polymer is selected from the group of epoxies, alkyds, and acrylics.

In one embodiment the epoxies are selected from the group of bisphenol A epoxy resin, bisphenol F epoxy resin, novolac epoxy resin, aliphatic epoxy resin, and glycidylamine epoxy resin.

In one embodiment curing agent is preferably an amine based curing agent.

In one embodiment the nonvolatile portion of the coating composition is dispersed in organic solvents (i.e., the volatile portion). Examples of organic solvents are N-methyl-2-pyrrolidone (NMP), dimethylformamide (DMF).

In one embodiment the coating composition comprises apart from graphene material, compounds selected from the group bisphenol A epoxy resin as polymer, isopropylamine as curing agent, and N-methyl-2-pyrrolidone (NMP) as solvent.

In one embodiment the nonvolatile content, i.e., graphene material, polymer and curing agent (solid content) present in the coating composition is about 55-75 wt %.

In one embodiment the presence of graphene material in the nonvolatile content of the coating composition is about 0.1-5 wt %. In one embodiment the amount of polymer present in the nonvolatile portion of the coating composition is about 50-65 wt %. In one embodiment the amount of curing agent present in the nonvolatile portion of the coating composition is about 30-45 wt %.

In one embodiment the volatile portion of the coating composition (i.e., organic solvent) is about 25-45 wt %.

In one embodiment said graphene and/or graphene oxide, and polymer are provided in the form of a polymer functionalized graphene or graphene oxide; and/or said graphene and/or graphene oxide are in forms functionalized with amine. In one embodiment the amine used to functionalize is preferably selected from diamines.

One objective of the present invention is to provide a method for the production of the present coating composition comprising the following steps: providing a graphene powder and/or graphene oxide powder; dispersing said powder, e.g., in organic solvent, to provide a dispersion; and admixing a polymer to said dispersion to obtain said coating composition.

In one embodiment the powder is dispersed by ultrasonication, e.g., in solvent such as NMP, to provide a uniform dispersion of graphene material.

In one embodiment the dispersed graphene material is admixed with a polymer and curing agent; which may be ultrasonicated in the presence of additional amounts of organic solvent to obtain the above said coating composition.

In one embodiment coating additives are added to the dispersion during and/or after the addition of the polymer.

One objective of the present invention is to provide a method for providing the present coating composition on metal substrates comprising the step of applying the coating to the metal substrate; preferably the coating composition is applied to the metal substrate using an application method selected from the group of spray coating, brush coating, roller coating and dip coating.

In one embodiment the application method further comprises drying the coating.

In one embodiment the drying is performed by subjecting the coated container to thermal curing.

One objective of the present invention is to use the present coating for prevention and inhibition of microbial growth in present biofuel and to protect the surface of the metal in contact with biofuel from corrosion. It is preferable that the microorganisms reduced are selected from the group of sulfate-reducing bacteria, polymer-degrading bacteria, and acid-producing bacteria.

### BRIEF DESCRIPTION OF THE DRAWINGS

Illustrated embodiments are described in detail below with reference to the attached drawing figures, which are incorporated by reference herein, and where:

FIG. 1 shows an overview of the invention, showing the major stages in synthesis of GO-epoxy and its application as the interior liner of mild steel tank used for biodiesel storage.

### DETAILED DESCRIPTION

Graphene oxide (GO) is a hydrophilic substance and disperses in a range of solvents and polymers. The graphene oxide is characterized by sharper edges that can puncture membranes of exposed microbial cells. GO is therefore characterized by its biocidal nature. GO can be used as a protective pigment to develop bifunctional liners that offer simultaneous advantages by providing anticorrosive and antimicrobial properties. GO powders can be blended with polymers to obtain anticorrosive, GO-polymer liners. The GO-polymer liners reduce moisture penetration into underlying steel substrates. It can also reduce microbial corrosion. Alternatively, GO may be functionalized with polymers in order to increase its bioavailability and facilitate a greater interaction with bacteria.

The present invention relates to a coating composition which may be applied to metals in contact with biofuels, such as biodiesel. The coating may be used for coating, i.e., lining, the inside of a container, which container is intended to contain biofuel. Containers, such as tanks, intended for biofuel storage, are coated according to the present invention with a coating composition comprising graphene and/or graphene oxide, and a polymer. The coating composition comprises at least one compound selected from graphene and graphene oxide, which may be chemically modified. Herein the combination may be referred to as graphene-polymer or graphene oxide-polymer, wherein the names of specific polymers may replace the general wording polymer.

Herein graphene and graphene oxide may be referred to as the graphene materials.

The present composition may comprise the graphene materials and polymer in combination, wherein the graphene materials may be provided in unfunctionalized or functionalized form. Graphene materials may be provided in functionalized form by covalently or non-covalently attaching functional groups such as —NH₂ on their surfaces. Graphene materials when provided in functionalized form improves their dispersivity in polymers, facilitates better adhesion on the metal surface thereby preventing coating delamination.

The amount of graphene or graphene oxide present in the present composition may be about 0.1-8 wt %. Further examples of the composition's content of the graphene materials are 0.1-5 wt %, 0.2-2 wt %, and 0.2-1 wt %.

The type of polymer used influences the overall performance of the present coating composition. The polymer may be selected from the group of epoxies, alkyds, and acrylics.

Suitable epoxies may be selected from the group of bisphenol A epoxy resin, bisphenol F epoxy resin, novolac epoxy resin, aliphatic epoxy resin, and glycidylamine epoxy resin.

Suitable alkyds may be obtained from the group of dicarboxylic acids or anhydrides, such as phthalic anhydride or maleic anhydride, and polyols, such as trimethylolpropane, glycerine, or pentaerythritol.

Suitable acrylics may be selected from the group of related thermoplastic or thermosetting plastic substances derived from acrylic acid, methacrylic acid or other related compounds.

The amount of polymer present in the nonvolatile portion of the coating composition may be about 50-65 wt %, such as 55-60 wt %.

The amount of amine curing agent in the nonvolatile portion of the coating composition may be about 30-45 wt %, such as 30-40 wt % or 30-35 wt %.

The amount of volatile portion of the coating composition, i.e., organic solvent present in the composition may be about 25-45 wt %, such as 30-40 wt % or 30-35 wt %.

Suitable curing agents may be selected from the group of cycloaliphatic amines, aromatic amines, aliphatic oligoamines, aliphatic diamines, etherdiamines, imidazoles, and imidazolines. Examples of curing agents are isophorone diamine, 4,4′-diamino-dicyclohexylmethane, 3′-dimethyl-4,4′diamino-dicyclohexylmethane, 3-cyclohexylamino-propylamine, 4,4′-diaminodiphenyl-methane, ethylenediamine, 1,3-diaminopropane, dimethylaminopropylamine, diethylaminopropylamine, bis(3-aminopropyl)-methylamine, diethylenetriamine, dipropylenetriamine, 3-(2-aminoethyl)amino-propylamine, N,N′-bis(3-aminopropyl)-ethylenediamine, neopentanediamine, 4,7-dioxadecane-1,10-diamine, 4,9-dioxadodecane- 1,12-diamine, 4,7,10-trioxatridecane-1,13-diamine, polyetheramine, imidazole, 1-methylimidazole, 2-methylimidazole, 1,2-dimethylimidazole, 2-ethylimidazole, 1-vinylimidazole, 2-ethyl-4-methyl-imidazole, 2-ethyl-4-methyl-imidazole, and N-(3-Aminopropyl)-imidazole.

Suitable organic solvents may be selected from the group of pyrrolidones, and isopropylalcohol (IPA), such as N-methyl-2-pyrrolidone (NMP), N-n-butylpyrrolidone, N-isobutylpyrrolidone, N-t-butylpyrrolidone, N-n-pentylpyrrolidone, N-(methyl-substituted butyl)pyrrolidones, ring-methyl-substituted N-propyl and N-butyl pyrrolidones and N-(methoxypropyl) pyrrolidone.

The graphene and/or graphene oxide may be present in functionalized forms, i.e., functionalized with amine. An amine functionalized graphene and/or graphene oxide means that the amine has at least partially been attached or incorporated with the graphene materials. Preferred amines to functionalize the graphene materials are diamines. The diamines may be selected from the group of aliphatic diamines and aromatic diamines. Examples of different diamines being aliphatic or aromatic are hydrazine, ethylene diamine, 1,3-diaminopropane, putrescine, cadaverine, hexamethylene diamine, o-xylylene diamine, m-xylylene diamine, p-xylylene diamine, o-phenylene diamine, m-phenylene diamine, p-phenylene diamine, and dimethyl-4-phenylene diamine. Herein the combination may be referred to as functionalized graphene-polymer or functionalized graphene oxide-polymer, wherein the names of specific polymers may replace the general wording polymer.

As mentioned above, the graphene and/or graphene oxide used may be functionalized using amines. Graphene and/or graphene oxide functionalized with the amine groups promote adherence to metal substrates, such as steel and stainless steel substrates.

Functionalization techniques may be used to increase the surface area of the present compositions comprising graphene and/or graphene oxide, and polymer, and promote the interaction between the graphene and/or graphene oxides, and the microorganisms present in the biofuel (e.g., sessile and film-forming microorganisms).

Providing amine functionalized forms of graphene and/or graphene oxide may further improve dispersivity and the biocidel action of the composition according to the present invention.

As indicated above, a modified graphene and/or graphene oxide, i.e., an amine functionalized graphene and/or graphene oxide may increase the adhesive strength of the coating composition, and increase the bioavailability to facilitate greater bacterial interactions.

According to one embodiment the coating composition comprises graphene-epoxy, or graphene oxide-epoxy, preferably functionalized graphene reinforced epoxy or functionalized graphene oxide reinforced epoxy.

The present invention also relates to a method for the production of a coating composition according to the present invention. The method comprises the steps of providing a graphene and/or graphene oxide powder; dispersing said powder, e.g., in organic solvent, to provide a dispersion; and admixing a polymer to said dispersion to obtain said coating composition.

In one embodiment the powder is dispersed by ultrasonication, e.g., in solvent such as NMP, to provide a uniform dispersion of graphene material.

In one embodiment a curing agent is added to the dispersion, e.g., at the same or similar time as the polymer.

Graphene oxide powder may be obtained by a known method called modified Hummers' method. This modified Hummers' method is e.g., disclosed in “Improved synthethis of graphene oxide”, by D. C. Marcano et al, ASCNANO, vol. 4, no. 8, pages 4806-4814, Jul. 22, 2010.

Graphene powder may be obtained by first obtaining graphene oxide by a known method called modified Hummers' method. The graphene oxide obtained by modified Hummers' method may be thermally functionalized to obtain graphene.

The powder of graphene material may be dispersed in organic solvent, such as NMP.

During the processing said dispersing and/or admixing may be performed using a mixing device, such as an ultrasonicator.

The polymer and curing agent may be added to above dispersion of graphene material and the entire mixture is ultrasonicated. The addition of the polymer and optional curing agent may be performed before and/or during and/or after providing the dispersion of graphene material, e.g., in NMP.

The present coating composition may be applied onto metal substrates, e.g., metal containers. The application method may comprise the step of application of the coating to the container. The coating composition may be applied to the interior of a container, i.e., the inner surfaces of the container. The coating composition may be applied to the metal substrate using a method selected from the group of spray coating, brush coating, roller coating, and dipping. One type of spray coating that may be used is airless-spray coating.

The application method may further comprise drying the coating. The drying may be performed by subjecting the coated metal substrate to heat. The drying may be performed at a temperature of about 150-180° C. for quick curing. Solvents which may be evaporated in a heating and/or drying apparatus, e.g., an oven, during curing of the present coating may be condensed and collected in a container. The collected solvent may be recycled back to the present process for reuse. Recycling and reusing solvent, e.g., NMP, in a closed loop minimizes the consumption of fresh solvent.

The coating composition may be applied more than one time. It may be applied at least twice, and result in the forming a multilayer coating. The multiple coating of the metal substrate may occur with or without intermediate drying steps. Thus, the drying step may be performed as a step after multiple coatings have been applied or after each coating step in a subsequent manner.

The coating thickness of the coating on the metal substrate may be in a range of about 50-300 μm, such as 100-200 μm, or 75-150 μm. The coating thickness is measured on the finally obtained dry coating on the metal substrate. The thickness of the coating on the metal may be decreased in comparison with conventional epoxy liners. For conventional epoxy liners the coating thickness is normally in the range of about 400-500 μm. The graphene-polymer coatings or graphene oxide-polymer coatings according to the present invention may have a coating thickness of about 100-300 μm to provide a similar effect.

The coating according to the present invention may be used for preventing growth of microorganisms in biofuel. The microorganisms which may be reduced by the use of the present coating may be selected from the group of sulfate-reducing bacteria, polymer-degrading bacteria, and acid-producing bacteria. The sulfate-reducing bacteria may be selected from the Desulfobacterales, Desulfovibrionales and Syntrophobacterales within Deltaproteobacteria. The polymer-degrading bacteria may be selected from the group of Stenotrophomonas spp within Gammaproteobacteria. The acid-producing bacteria may be selected from the group of Clostridium spp and Escherichia spp.

The coating according to the present invention may be used for reduction of corrosion of metal in contact with biofuel.

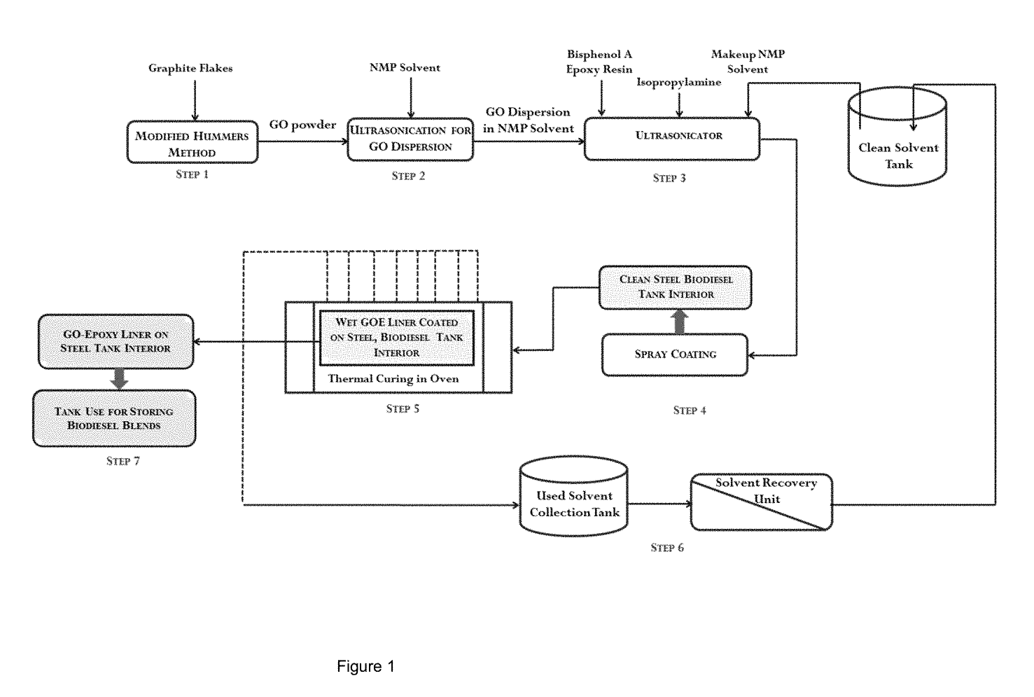

FIG. 1 shows a process of obtaining a GO-epoxy liner and incorporating it on interior steel surface of a biodiesel tank. The GO-epoxy synthesis and application is disclosed in the following steps: (i) the dry GO powder is obtained by using the modified Hummer's method; (ii) the GO powder is dispersed in NMP solvent and ultrasonicated; (iii) the GO is mixed with epoxy resin components, i.e., binder and curing agents in presence of NMP solvent and ultrasonicated; (iv) the GO-epoxy solution is spray coated on the interior surface of steel tank; (v) the spray coated tank surface is thermally cured in an oven; (vi) the volatile part of the coating (i.e., solvent) is evaporated and condensed in a solvent recovery tank from which it is continuously recycled back into the system; and (vii) the steel tank with GO-epoxy liner is used to store biodiesel and/or its blends.

### EXAMPLE

### Synthesis of GO Powder:

Graphene oxide is synthesized via Modified Hummer's method.

### Dispersion Formation:

The GO powder obtained is dispersed in deionized water and ultrasonicated for 2 hours.

### Synthesis of GO-Polymer Coating Composition:

Additional polymer, hardener and solvent is added to the GO dispersion to provide a coating composition. The coating composition comprises 0.25 wt % GO, 45 wt % Bisphenol A epoxy resin, 21.75 wt % isopropylamine as a curing agent and 33 wt % N-methyl-2-pyrrolidone as solvent to provide a GO-epoxy composition to be used as a corrosion protection liner for the interior of biodiesel storage tanks.

### Coating the Composition on a Tank:

Surface preparation is performed in two steps: (a) degreasing to remove oil and grease impurities from the metal surfaces; (b) shot blasting (with stainless shots) for additional cleaning. Shot blasting consumes energy at a rate of 1.0-1.5 KWh/m ².
Airless spray is used to apply the coating composition with a transfer efficiency of 74%. A double coat of 100 μm thickness (Dry film thickness (DFT)) with a total DFT of 200 μm is applied on the steel metal. The volume solids in the coating is 60%.

### Oven Curing of the Wet Coating:

The liner is assumed to be dried in hot air oven. Electricity usage was 0.126 KWh/m² and usage of natural gas 2.48 MJ.

### Solvent Collection and Recovery System:

90% of the solvent is recovered and reused in a closed system. 10% of make-up solvent is considered as material input to the synthesis of coating composition. 10% of the solvent is lost as VOCs. The processing burdens of solvent recovery unit (in terms of electrical energy) is 0.7 KWh/kg.
   Biodiesel Storage in Steel Tank with Coating Composition:
The lifespan of GOE liner is considered to be at least 20 years. The only maintenance activity is to continuously inspect the integrity of coating composition in the tank. Additional recoating is not required.

What is claimed is:

1. A coating composition for application on metal substrates intended for contact with biofuel, the coating composition comprising:
a nonvolatile portion and a volatile portion, wherein the nonvolatile portion of the coating composition comprises a graphene and a polymer, and optionally an amine based curing agent, wherein the polymer is an alkyd selected from the group of dicarboxylic acids or anhydrides.

2. The coating composition according to claim 1, wherein said nonvolatile portion is about 55-75 wt % of the coating composition.

3. The coating composition according to claim 1, wherein said polymer is selected from the group of:
epoxies, wherein the epoxies are selected from the group of dicarboxylic acids or anhydrides; and
acrylics, wherein the acrylics are selected from the group of thermoplastic or thermosetting plastics derived from acrylic acid or methacrylic acid.

4. The coating composition according to claim 3, wherein said epoxies are selected from the group of bisphenol A epoxy resin, bisphenol F epoxy resin, novolac epoxy resin, aliphatic epoxy resin, and glycidylamine epoxy resin.

5. The coating composition according to claim 1, wherein said amine based curing agent is selected from the group of cycloaliphatic amines, aromatic amines, aliphatic oligoamines, aliphatic diamines, etherdiamines, imidazoles, and imidazolines.

6. The coating composition according to claim 1, wherein said volatile portion is organic solvents, which are selected from the group of pyrrolidones and isopropylalcohol.

7. The coating composition according to claim 6, wherein said organic solvents are selected from the group of N-methyl-2-pyrrolidone, dimethylformamide and isopropyl alcohol.

8. The coating composition according to claim 1, wherein the amount of graphene or graphene oxide in the nonvolatile portion of coating composition is 0.1-5 wt %.

9. The coating composition according to claim 1, wherein the amount of polymer present in the nonvolatile portion of the composition is about 50-65 wt %.

10. The coating composition according to claim 1, wherein the amount of curing agent present in the nonvolatile portion of coating composition is about 30-45 wt %.

11. The coating composition according to claim 1, wherein the volatile portion of the coating composition is about 25-45 wt %.

12. The coating composition according to claim 1, wherein said graphene and/or graphene oxide are in forms functionalized with amine or diamines.

13. A method for the production of a coating composition, comprising the steps of:
providing a graphene powder and/or graphene oxide powder;
dispersing said powder in an organic solvent to provide a dispersion; and
admixing a polymer and optional curing agent to said dispersion to obtain said coating composition, wherein the polymer is an acrylic selected from the group of a thermoplastic or a thermosetting plastic derived from acrylic acid or methacrylic.

14. The method according to claim 13, wherein coating additives are added to the dispersion.

15. The method according to claim 13, further comprising:
applying the coating to the metal substrate wherein said coating application method is selected from the group of spray coating, brush coating, roller coating, and dip coating.

16. The method according to claim 13, further comprising:
drying the coating by subjecting the coated container to heat.

17. The method of claim 13, further comprising:
reducing microorganisms present in biofuel and/or corrosion of metal in contact with biofuel with the coating.

18. The method of claim 17, further comprising:
selecting microorganisms from the group of sulfate-reducing bacteria selected from the group of Desulfobacterales, Desulfovibrionales and Syntrophobacterales within Deltaproteobacteria.

19. The method of claim 17, further comprising:
selecting microorganisms from the group of polymer-degrading bacteria selected from the group of Stenotrophomonas spp within Gammaproteobacteria.

20. The method of claim 17, further comprising:
selecting microorganisms from the group of acid-producing bacteria selected from the group of Clostridium spp and Escherichia spp.
